(19) United States
(12) Patent Application Publication
(10) Pub. No.: US 2026/0111150 A1
(43) Pub. Date: Apr. 23, 2026

(54) NON-VOLATILE MEMORY DEVICE AND STORAGE DEVICE INCLUDING THE SAME

(71) Applicant: Samsung Electronics Co., Ltd., Suwon-si (KR)

(72) Inventors: Eunhyang Park, Suwon-si (KR); Jin-Young Kim, Suwon-si (KR); Se Hwan Park, Suwon-si (KR)

(21) Appl. No.: 19/311,837

(22) Filed: Aug. 27, 2025

(30) Foreign Application Priority Data
Oct. 17, 2024 (KR) 10-2024-0141930

(51) Int. Cl. G06F 3/06

(52) U.S. Cl. CPC G06F 3/0659; G06F 3/0604; G06F 3/0679

(57) ABSTRACT

A storage device includes a memory device and a storage controller transmitting a command indicating a valley search operation on a word line to the memory device. The memory device is configured to determine read voltage candidates for determining a read voltage corresponding to a valley between threshold voltage distributions associated with first and second memory states; generate read data through read operations using the read voltage candidates and store the read data in the page buffers; output first read data generated through a first read operation using a first read voltage candidate; transmit the first read data to the storage controller; and based on a failure of error correction of the first read data, output second read data generated through a second read operation using a second read voltage candidate, and transmit the second read data to the storage controller.

### CROSS-REFERENCE TO RELATED APPLICATION(S)

This application claims priority under 35 U.S.C. § 119 to Korean Patent Application No. 10-2024-0141930, filed in the Korean Intellectual Property Office on Oct. 17, 2024, the entire contents of which are hereby incorporated by reference.

### BACKGROUND

A memory device may provide a function to write and erase data, or read recorded data. The memory device executes a program operation, an erase operation, a read operation, etc. in response to control signals transmitted from a storage controller, and data acquired by the memory device in the read operation may be output to the storage controller.

If the memory device fails to correct an error in the read data output as a result of the read operation for valley search, the memory device may execute an additional read operation for the valley search. In this case, there is a problem that latency occurs in the valley search operation as the additional read operation is performed.

### SUMMARY

In order to solve one or more problems (e.g., the problems described above and/or other problems not explicitly described herein), the present disclosure provides a non-volatile memory device and a storage device including the same.

An object to be achieved by the present disclosure is not limited to the objects described above, and other objects not mentioned can be clearly understood by those skilled in the art from the description of the present disclosure below.

According to some aspects of the disclosure, a storage device may include a memory device including a selected word line connected with selected memory cells and page buffers that sense states of the selected memory cells, and a storage controller configured to transmit a command indicating a valley search operation for the selected word line to the memory device, in which the memory device may be configured to, in response to receiving the command, determine a plurality of read voltage candidates for determining a read voltage corresponding to a valley between threshold voltage distributions associated with first and second states of the selected memory cells and overlapping with each other, generate read data through a plurality of read operations using the plurality of read voltage candidates for the selected word line and store the read data in the page buffers, output, from the page buffers, first read data generated through a first read operation using a first read voltage candidate and transmit the first read data to the storage controller, and in response to a failure of error correction of the first read data in the storage controller, output, from the page buffers, second read data generated through a second read operation using a second read voltage candidate and transmit the second read data to the storage controller.

According to some aspects of the disclosure, a storage device may include a memory device including a selected word line connected with selected memory cells and page buffers that sense states of the selected memory cells, and a storage controller configured to transmit a command indicating a valley search operation for the selected word line to the memory device, in which the memory device may be configured to, in response to receiving the command, determine a plurality of read voltage candidates for determining a read voltage corresponding to a valley between threshold voltage distributions associated with first and second states of the selected memory cells and overlapping with each other, generate read data through a plurality of read operations using the plurality of read voltage candidates for the selected word line and store the read data in the page buffers, determine priorities of each of the plurality of read voltage candidates, and output, from the page buffers, first read data generated through a read operation using a read voltage candidate having the highest determined priority among the plurality of read voltage candidates, and transmit the first read data to the storage controller.

According to some aspects of the disclosure, a memory device may include a memory cell array including memory cells, a page buffer circuit including page buffers connected to the memory cells through bit lines and sensing states of selected memory cells connected to a selected word line of the memory cells, and a control logic circuit configured to control the page buffer circuit, in which the control logic circuit may be configured to determine a plurality of read voltage candidates for determining a read voltage corresponding to a valley between threshold voltage distributions associated with first and second states of the selected memory cells and overlapping with each other, generate read data through a plurality of read operations using the plurality of read voltage candidates for the selected word line and store the read data in the page buffers, output, from the page buffers, first read data generated through a first read operation using a first read voltage candidate, and in response to a failure of error correction of the first read data, output, from the page buffers, second read data generated through a second read operation using a second read voltage candidate.

According to some aspects of the present disclosure, even if error correction of read data for the valley search fails, it is not necessary to generate read data through a separate read command. As a result, there is no latency occurring in the memory device due to the execution of an additional read operation, and it is possible to enhance the performance reliability of the memory device.

According to some aspects, by determining a read voltage candidate using a weighted average value that weights a voltage level that falls within a threshold voltage range having a lower cell count value, the accuracy of the valley search operation can be improved.

According to some aspects, by directly using the cell count read voltages as the read voltage candidates, a read voltage corresponding to the valley can be determined without performing an additional read operation with separately determined read voltage candidates, thus allowing the valley search operation to be efficiently performed.

Various and beneficial advantages and effects of the present disclosure are not limited to those described above, and can be more easily understood in the course of describing specific aspects of the present disclosure.

### BRIEF DESCRIPTION OF THE DRAWINGS

The above and other objects, features and advantages of the present disclosure will become more apparent to those of ordinary skill in the art by describing in detail example aspects thereof with reference to the accompanying drawings.

FIG. 1 is a diagram schematically illustrating an example of a storage device including a memory device.

FIG. 2 is a diagram schematically illustrating an example of a memory device.

FIG. 3 is a circuit diagram schematically illustrating an example of a memory cell array included in a memory device.

FIGS. 4A and 4B are diagrams illustrating examples of threshold voltage distributions associated with states of a selected word line of a memory device.

FIG. 5 is a flowchart provided to explain an example of a method for initiating an OVS operation of a storage device.

FIG. 6 is a flowchart provided to explain an example of a method for performing an OVS operation in the storage device of FIG. 5.

FIG. 7A is a diagram schematically illustrating an example of a memory device.

FIG. 7B is a schematic diagram illustrating an example of some components included in a memory device to explain an operation of the memory device.

FIG. 8 is a diagram illustrating an example of a plurality of read voltage candidates applied to selected word lines using the memory devices of FIGS. 7A and 7B.

FIG. 9 is a diagram illustrating an example in which the read data is stored in a latch circuit of a page buffer circuit.

FIG. 10A is a diagram illustrating an example of a page buffer in detail.

FIG. 10B is a diagram illustrating an example in which data is stored in different latches of a page buffer.

FIG. 10C is a diagram illustrating an example in which data is stored in different latches of a page buffer.

FIG. 11 is a flowchart provided to explain an example of a method for performing an OVS operation in the storage device of FIG. 5.

FIG. 12 is a diagram illustrating an example of priorities of the read voltage candidates according to some aspects.

FIG. 13 is a flowchart provided to explain the operation S1120 of FIG. 11 in detail.

FIG. 14 is a diagram provided to explain an example of determining a read voltage corresponding to the valley using a plurality of read voltage candidates.

FIG. 15 is a flowchart provided to explain an example of a method for performing an OVS operation in the storage device of FIG. 5.

FIG. 16 is a flowchart provided to explain the operation S1520 of FIG. 15 in detail.

FIG. 17 is a diagram provided to explain an example of determining a read voltage corresponding to the valley using a plurality of read voltage candidates.

### DETAILED DESCRIPTION

Hereinbelow, certain aspects of the present disclosure will be described with reference to the accompanying drawings.

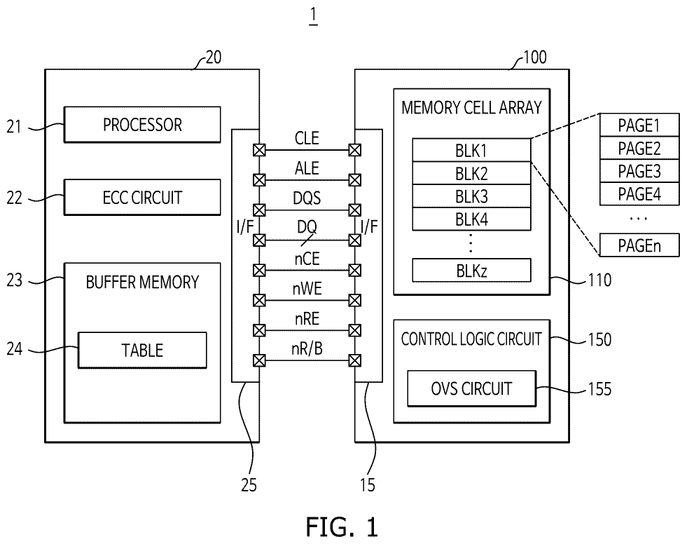

FIG. 1 is a diagram schematically illustrating a storage device including a memory device.

Referring to FIG. 1, a storage device 1 may include at least one memory device 100, a storage controller 20, etc. The memory device 100 may be implemented to store data. The memory device 100 may include a NAND flash memory, a vertical NAND flash memory, a NOR flash memory, a resistive random access memory (RRAM), a phase-change memory (PRAM), a magneto-resistive random access memory (MRAM), a ferroelectric random access memory (FRAM), a spin transfer torque random access memory (STT-RAM), etc. In addition, the memory device 100 may be implemented in a three-dimensional array structure.

The memory device 100 may include a memory cell array 110, a control logic circuit 150, a memory interface 15, etc. The memory cell array 110 may include a plurality of memory blocks BLK1 to BLKz. Each of the plurality of memory blocks BLK1 to BLKz may include a plurality of pages PAGE1 to PAGEn, and a plurality of memory cells may be included in each of the plurality of pages PAGE1 to PAGEn. Each of the memory cells may store one or more bits, and for example, two or more bits of data may be stored in one memory cell.

The control logic circuit 150 may control the memory cell array 110 in response to control signals received from the storage controller 20 through the memory interface 15. For example, the control logic circuit 150 may exchange control signals with the storage controller 20 when a chip enable signal nCE is in an enabled state. The control logic circuit 150 may acquire a command signal and an address signal included in a data signal DQ during an enable period of the command latch enable signal CLE and the address latch enable signal ALE. For example, the control logic circuit 150 may acquire a command signal and/or an address signal from the data signal DQ at a toggle timing of a read enable signal nRE and a write enable signal nWE. The control logic circuit 150 may execute a read operation, a program operation, an erase operation, etc. with reference to the command signal and the address signal.

The control logic circuit 150 may be synchronized with a data strobe signal DQS to output read data through the data signal DQ, or may be synchronized with the data strobe signal DQS to acquire write data included in the data signal DQ. For example, before outputting read data, the control logic circuit 150 or the memory interface 15 may generate a data strobe signal DQS with reference to the read enable signal nRE. The memory interface 15 may output the read data through the data signal DQ synchronized with the data strobe signal DQS. In addition, the control logic circuit may transmit the state of the memory device 100 to the storage controller 20 using the ready/busy signal nR/B.

In addition, the control logic circuit 150 may include an OVS circuit 155. The OVS circuit 155 may be a circuit that performs a valley search operation for determining an optimal read voltage. The valley search operation executed by the OVS circuit 155 may be defined as an on-chip valley search operation executed in the memory device 100. A detailed description of the on-chip valley search operation may be understood by referring to KR10-2019-0025359, US2020-0098436, U.S. Pat. Nos. 10,090,046, 10,559,362, 10,607,708, 10,629,259, etc., which are hereby incorporated by reference.

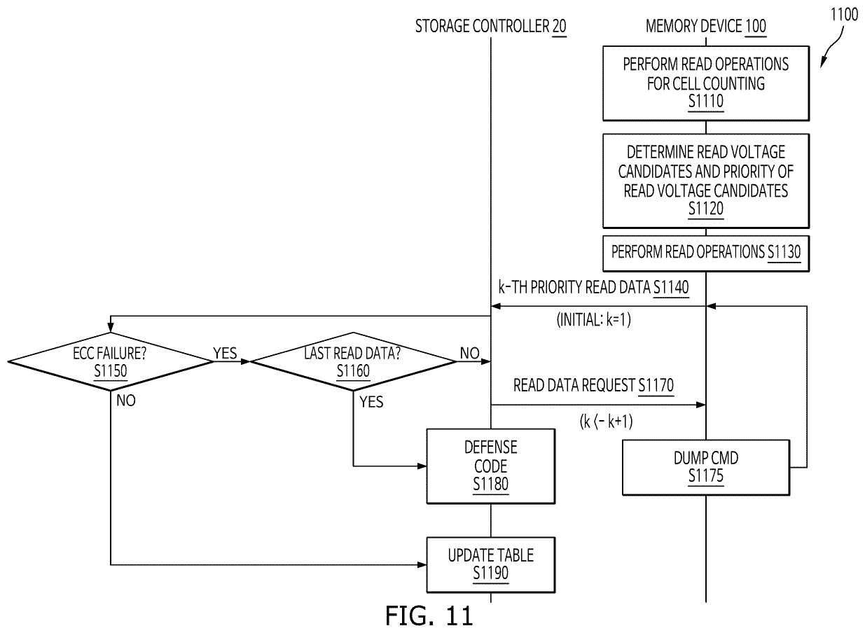

In the valley search operation, the control logic circuit 150 may detect on/off states of the selected memory cells connected to the selected word line while applying a plurality of read voltages having different levels to the selected word line. The control logic circuit 150 may calculate a cell count value according to a threshold voltage distribution (or threshold voltage dispersion) of the selected memory cells. The cell count value may be used to determine an optimal read voltage in consideration of the threshold voltage distribution of the selected memory cells. For example, the control logic circuit 150 may directly determine an optimal read voltage using the cell count value. Alternatively, the storage controller 20 may receive the cell count value from the memory device 100, determine an optimal read voltage based on the cell count value, and transfer the optimal read voltage to the memory device 100. The cell count value may be calculated for each of a plurality of threshold voltage ranges in the threshold voltage distribution, and the cell count value calculated for each of the plurality of threshold voltage ranges may be used to determine an optimal read voltage. This will be described in detail below with reference to FIGS. 11 to 17.

The storage controller 20 may include a processor 21, an error correction circuit 22, a buffer memory 23, a controller interface 25, etc. The processor 21 may control the overall operation of the storage controller 20 and generate a command signal for controlling the memory device 100, an address signal, etc. The controller interface 25 may be connected to the memory interface 15 through control pins and data pins. Control signals such as a command latch enable signal CLE, an address latch enable signal ALE, a data strobe signal DQS, a chip enable signal nCE, a read enable signal nRE, a write enable signal nWE, a ready/busy signal nR/B, etc. may be transmitted through the control pins, and the data signal DQ may be transmitted through the data pins.

The error correction circuit 22 may generate an error correction code in the program operation, and in the read operation, may correct an error of read data received from the memory device 100 using the error correction code. The error correction circuit 22 may correct the error using coded modulation such as low density parity check (LDPC) code, BCH code, turbo code, Reed-Solomon code, convolution code, recursive systematic code (RSC), trellis-coded modulation (TCM), block coded modulation (BCM), etc.

The buffer memory 23 may store a table 24. For example, information necessary to determine an optimal read voltage in consideration of time elapsed after programming, temperature of the memory device 100, program/erase cycle, address of the selected memory cell, etc. may be recorded in the table 24. For example, if an uncorrectable error correction code (UECC) error occurs due to a failure in error correction of read data acquired by executing a read operation on a selected memory cell at a specific address, the memory device 100 may execute a valley search operation, and the memory device 100 or the storage controller 20 may determine an optimal read voltage. The determined optimal read voltage may be recorded in the table 24, and when the read operation for the same selected memory cell is subsequently executed again, the storage controller 20 may instruct the memory device 100 to perform the read operation with the optimal read voltage stored in the table 24.

According to some aspects, the buffer memory 23 may include a machine learning model. The machine learning model may be pre-trained to receive a cell count value, etc. generated in a valley search operation and output an optimal read voltage.

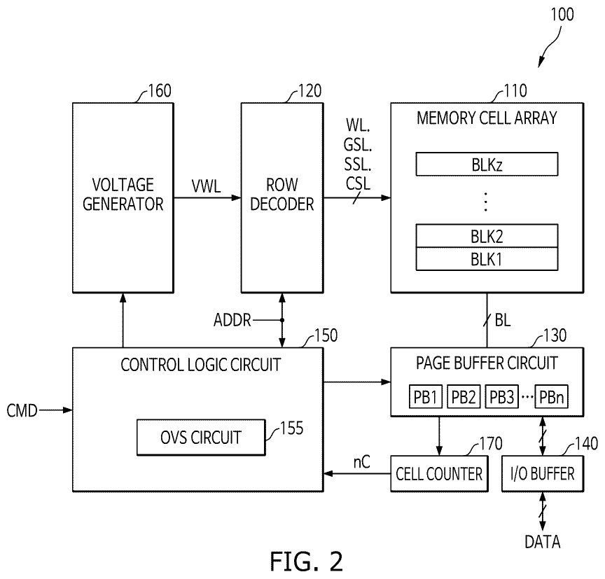

FIG. 2 is a diagram schematically illustrating the memory device 100.

Referring to FIG. 2, the memory device 100 may include the memory cell array 110, a row decoder 120, a page buffer circuit 130, an input/output buffer 140, the control logic circuit 150, a voltage generator 160, a cell counter 170, etc. For example, the memory device 100 illustrated in FIG. 2 may be a NAND flash memory. The memory cell array 110 may be disposed in a cell region, and the row decoder 120, the page buffer circuit 130, the input/output buffer 140, the control logic circuit 150, the voltage generator 160, and the cell counter 170 may be disposed in a peripheral circuit region.

The memory cell array 110 may be connected to the row decoder 120 through word lines WL or selection lines SSL and GSL. The memory cell array 110 may be connected to the page buffer circuit 130 through bit lines BL. The memory cell array 110 may include a plurality of cell strings. Channel of each cell string may be formed in a vertical or horizontal direction, and each of the cell strings may include a plurality of memory cells. In the memory cell array 110, the cell strings may be divided into the plurality of memory blocks BLK1 to BLKz.

The row decoder 120 may select at least one of the memory cells of the memory cell array 110 in response to the address ADDR. The row decoder 120 may determine at least one selected word line from among the word lines WL in response to the address ADDR. The row decoder 120 may transfer, to the selected word line of the word lines WL, a bias voltage for executing a program operation, a read operation, an erase operation, etc. During the program operation, the row decoder 120 may apply a program voltage and a verification voltage to the selected word line and apply a pass voltage to the unselected word lines. During the read operation, the row decoder 120 may apply a read voltage to the selected word line and apply a read pass voltage to the unselected word lines.

The page buffer circuit 130 may operate as a write driver or a sense amplifier. During the program operation, the page buffer circuit 130 may apply, to a selected bit line of the bit lines BL of the memory cell array 110, a bit line voltage corresponding to the data to be programmed. During the read operation or the verification operation, the page buffer circuit 130 may sense, through the selected bit line, the data stored in the selected memory cell. Each of a plurality of page buffers PB1 to PBn included in the page buffer circuit 130 may be connected to at least one bit line.

Each of the plurality of page buffers PB1 to PBn may be implemented to perform a valley search operation. Each of the memory cells may have one of a plurality of states according to recorded data, and each of the plurality of states may be defined according to a threshold voltage of each of the memory cells. Each of the plurality of page buffers PB1 to PBn may perform a sensing operation a plurality of times to identify the states of the selected memory cells under the control of the control logic circuit 150. For example, the plurality of sensing operations may be performed by applying a plurality of read voltage candidates to the selected memory cells. Each of the plurality of page buffers PB1 to PBn may store data acquired through a plurality of sensing operations, respectively, and select any one piece of data under the control of the control logic circuit 150. In addition, each of the plurality of page buffers PB1 to PBn may select or output optimal data from among a plurality of pieces of sensed data under the control of the control logic circuit 150.

The input/output buffer 140 may provide the page buffer circuit 130 with data provided from the outside. In addition, the input/output buffer 140 may provide the control logic circuit 150 with a command CMD provided from the outside. The input/output buffer 140 may provide the control logic circuit 150 and/or the row decoder 120 with an address ADDR provided from the outside. In addition, the input/output buffer 140 may output data sensed and latched by the page buffer circuit 130 to the outside.

The control logic circuit 150 may control the row decoder 120, the page buffer circuit 130, the voltage generator 160, etc. in response to a command CMD transmitted from the outside. In addition, the control logic circuit 150 may include the OVS circuit 155 that performs a valley search operation. The OVS circuit 155 may control the page buffer circuit 130 and the voltage generator 160 for the valley search operation. The OVS circuit 155 may control the page buffer circuit 130 to perform a plurality of sensing operations using a plurality of read voltage candidates to identify specific states of the selected memory cells. In addition, the OVS circuit 155 may store sensing data corresponding to each of the plurality of sensing results to a plurality of latch sets provided in each of the plurality of page buffers PB1 to PBn.

In addition, the OVS circuit 155 may store detection information generated in the OVS operation. The detection information may include cell count information nC generated in the OVS operation. The cell count information nC may include a cell count value in any threshold voltage distribution and/or a cell count value in any threshold voltage range in any threshold voltage distribution.

The OVS circuit 155 may output the detection information to an external storage controller. The detection information may be output in response to a special command transmitted by the storage controller such as, for example, a get feature command, a status read command, etc. The detection information may be stored in the storage controller and used to determine an optimal read voltage by modifying the level of the read voltage. In other aspects, however, the control logic circuit 150 may also determine the optimal read voltage using the detection information.

The cell counter 170 may be implemented to count memory cells having a threshold voltage in a specific range. For example, the cell counter 170 may count the number of memory cells having the threshold voltage in the specific range by processing data stored in each of the plurality of page buffers PB1 to PBn.

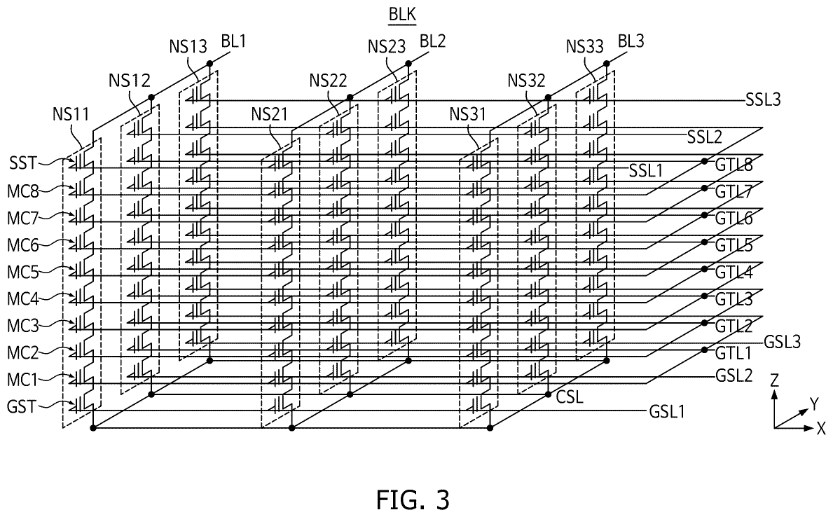

FIG. 3 is a circuit diagram schematically illustrating the memory cell array included in the memory device.

FIG. 3 is a diagram provided to explain a 3D V-NAND structure that may be applicable to the memory device of the storage device. If the memory device is implemented as a 3D V-NAND type flash memory, some memory cells included in each of the plurality of memory blocks in the memory cell array may be expressed by an equivalent circuit as illustrated in FIG. 3.

The memory block BLK illustrated in FIG. 3 represents a 3D memory block formed on a substrate in a 3D structure. For example, a plurality of memory NAND strings NS11 to NS13, NS21 to NS23, and NS31 to NS33 included in the memory block BLK may be formed in a direction perpendicular to the substrate.

Referring to FIG. 3, the memory block BLK may include the plurality of memory NAND strings NS11 to NS13, NS21 to NS23, and NS31 to NS33 connected between bit lines BL1 to BL3 and a common source line CSL. Each of the plurality of memory NAND strings NS11 to NS13, NS21 to NS23, and NS31 to NS33 may include a string selection transistor SST, a plurality of memory cells MC1 to MC8, and a ground selection transistor GST. FIG. 3 illustrates that each of the plurality of memory NAND strings NS11 to NS13, NS21 to NS23, and NS31 to NS33 includes eight memory cells MC1 to MC8, but aspects are not limited thereto.

The string selection transistor SST may be connected to corresponding string selection lines SSL1 to SSL3. The plurality of memory cells MC1 to MC8 may be connected to corresponding gate lines GTL1 to GTL8, respectively. The gate lines GTL1 to GTL8 may correspond to word lines, and some of the gate lines GTL1 to GTL8 may correspond to dummy word lines. The ground selection transistors GST may be connected to corresponding ground selection lines GSL1 to GSL3. The string selection transistors SST may be connected to corresponding bit lines BL1 to BL3, and the ground selection transistors GST may be connected to the common source line CSL.

Word lines at the same height within one block BLK may be connected in common, and the ground selection lines GSL1 to GSL3 and the string selection lines SSL1 to SSL3 may be separated from each other. FIG. 3 illustrates that the memory block BLK is connected to eight gate lines GTL1 to GTL8 and three bit lines BL1 to BL3, but aspects are not limited thereto. The number of gate lines and bit lines may be greater than those illustrated in FIG. 3.

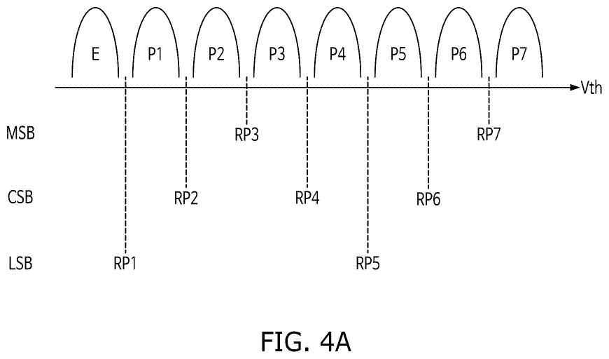

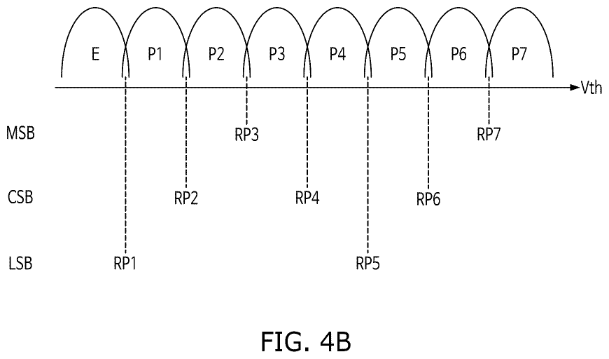

FIGS. 4A and 4B are diagrams illustrating examples of threshold voltage distributions associated with states of the selected word line of the memory device.

In the aspects illustrated in FIGS. 4A and 4B, each of the memory cells (e.g., selected memory cells) may store at least one or more bits. For example, the memory cell may be an SLC that stores 1-bit data. As another example, the memory cell may be an MLC that stores 2-bit data. As another example, the memory cell may be a TLC that stores 3-bit data. As still another example, the memory cell may be a quad-level cell (or a quadruple-level cell (hereinafter referred to as a QLC) that stores 4-bit data. However, aspects are not limited thereto. The aspect illustrated in FIGS. 4A and 4B are illustrated based on TLC, but aspects are not limited thereto, and the aspects of the present disclosure described below may also be applicable to SLC having two states (e.g., E and P1), MLC having four states (e.g., E, P1 to P3), QLC having 16 states (e.g., E, P1 to P15), etc. In the aspects to be described below, it is assumed that the memory cell is a TLC.

Referring to FIGS. 4A and 4B, in order to determine the data stored in each of the selected memory cells, read operation may be performed up to three times, and eight state information may be divided into three pages and outputted. The erase state E may be allocated as data “111”, the first program state P1 may be allocated as data “110”, the second program state P2 may be allocated as data “100”, the third program state P3 may be allocated as data “000”, the fourth program state P4 may be allocated as data “010”, the fifth program state P5 may be allocated as data “011”, the sixth program state P6 may be allocated as data “001”, and the seventh program state P7 may be allocated as data “101”. However, this is only an example, and the data allocated to the states E to P7 of each of the memory cells may vary depending on various aspects.

For example, the read operation of the lowest bit LSB may include a first read operation using a first read voltage RP1 between the erase state E and the first program state P1, and a second read operation using the fifth read voltage RP5 between the fourth program state P4 and the fifth program state P5. Likewise, the read operation of the most significant bit MSB may include a first read operation using the third read voltage RP3 between the second program state P2 and the third program state P3, and a second read operation using the seventh read voltage RP7 between the sixth program state P6 and the seventh program state P7. The read operation of the intermediate bit CSB may include a first read operation using the second read voltage RP2 between the first program state P1 and the second program state P2, a second read operation using the fourth read voltage RP4 between the third program state P3 and the fourth program state P4, and a third read operation using the sixth read voltage RP6 between the fifth program state P5 and the sixth program state P6. The read voltages RP1 to RP7 may be default read voltages which do not reflect the degree of deterioration of the memory cells or the memory block including the memory cells.

Ideally, the threshold voltage distribution of the memory cells may be illustrated as shown in FIG. 4A. In this case, the read data acquired from the selected memory cells using the read voltages RP1 to RP7 does not include an error, or the error correction circuit may correct the error. Meanwhile, as illustrated in FIG. 4B, the threshold voltage distribution of the selected memory cells may deteriorate due to time elapsed after the program operation, changes in the operating temperature of the memory device, accumulated number of executions of the program/erase operation and read operation, etc.

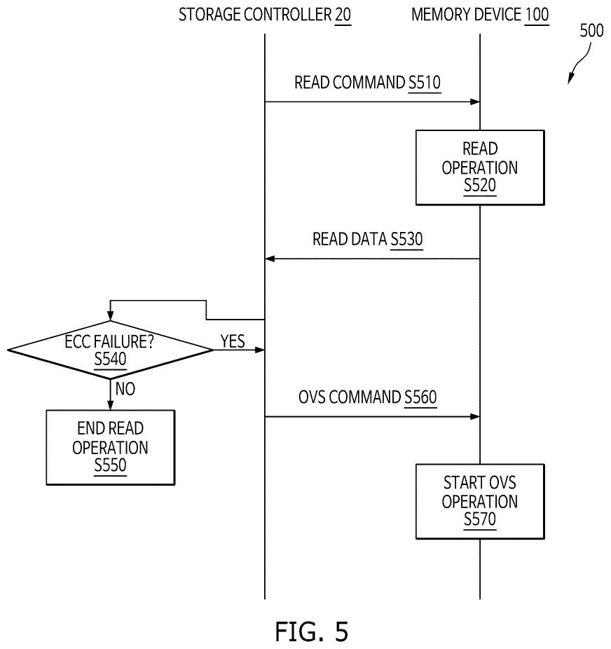

Referring to FIG. 4B, the threshold voltage distributions may overlap each other in at least some states E to P7. In this case, if the read operation is executed using the read voltages RP1 to RP7 as they are, the error correction circuit may fail to correct the error of the read data (e.g., UECC error may occur). If the error correction circuit of the storage controller receiving the read data fails to correct the error, the memory device may execute a valley search operation. In the valley search operation, read voltages of different levels may be input to the selected word line, and a cell count value may be determined in each of a plurality of threshold voltage ranges (e.g., in any range within a region where the threshold voltage distribution overlaps). The memory device or the storage controller may use the cell count value to determine an optimal read voltage capable of accurately determining some states E to P7 in which the threshold voltage distributions overlaps, and execute the read operation again using the optimal read voltage to accurately generate read data. Various aspects of determining the optimal read voltage will be described with reference to FIGS. 5 to 17.

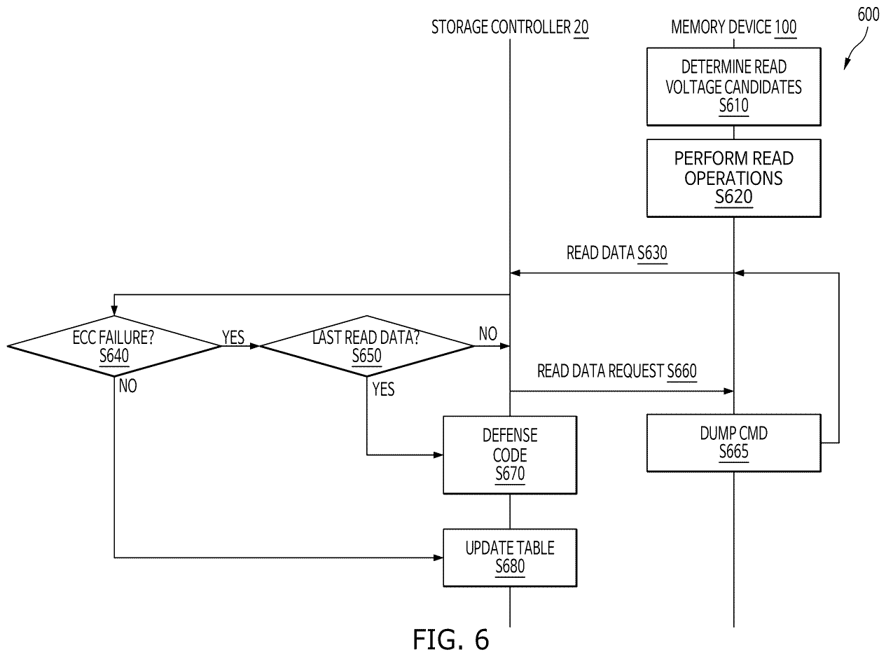

FIG. 5 is a flowchart provided to explain a method 500 for initiating an on-chip valley search (OVS) operation of the storage device, and FIG. 6 is a flowchart provided to explain a method 600 for performing the OVS operation in the storage device of FIG. 5. The methods 500 and 600 illustrated in FIGS. 5 and 6 may be performed by the storage device 1 including the storage controller 20 and the memory device 100 of FIG. 1. In the methods 500 and 600 illustrated in FIGS. 5 and 6, the operations illustrated as being performed by the memory device 100 may be controlled and/or performed by a control logic circuit (e.g., 150 in FIG. 1) of the memory device 100, but aspects are not limited thereto.

Referring to FIG. 5, the operation of the storage device may be initiated by the storage controller 20 transmitting a read command to the memory device 100, at S510. The memory device 100 (or the control logic circuit) may perform the read operation by referring to address information received together with the read command, at S520. The read operation at S520 may be a read operation using a default read voltage (e.g., the read voltages RP1 to RP7 in FIG. 4A).

The memory device 100 (or the control logic circuit) may transmit read data generated as a result of the read operation to the storage controller 20, at S530. The storage controller 20 may input the read data to the error correction circuit (e.g., 22 of FIG. 1) and determine whether the error correction fails (ECC failure), at S540.

If the error correction is successful as a result of the determination at S540, the storage controller 20 may end the read operation without any other additional operation, at S550.

Alternatively, if it is determined that the error correction has failed (e.g., a UECC error has occurred) at S540, the storage controller 20 may transmit an OVS command instructing a valley search operation for the selected word line to the memory device 100, at S560. In response to the received OVS command, the memory device 100 (or the control logic circuit) may initiate the valley search operation, at S570.

Referring to FIG. 6, in response to the start of the valley search operation at S570 of FIG. 5 (or in response to the memory device 100 receiving the OVS command), the memory device 100 (or the control logic circuit) may determine a plurality of read voltage candidates for determining a read voltage (e.g., an optimal read voltage) that corresponds to a valley between overlapping threshold voltage distributions of the selected memory cells connected to the selected word line, at S610. In this case, the threshold voltage distributions overlapping with each other may be threshold voltage distributions associated with any two states (e.g., P1 and P2 of FIG. 4B) of the states of the selected memory cells.

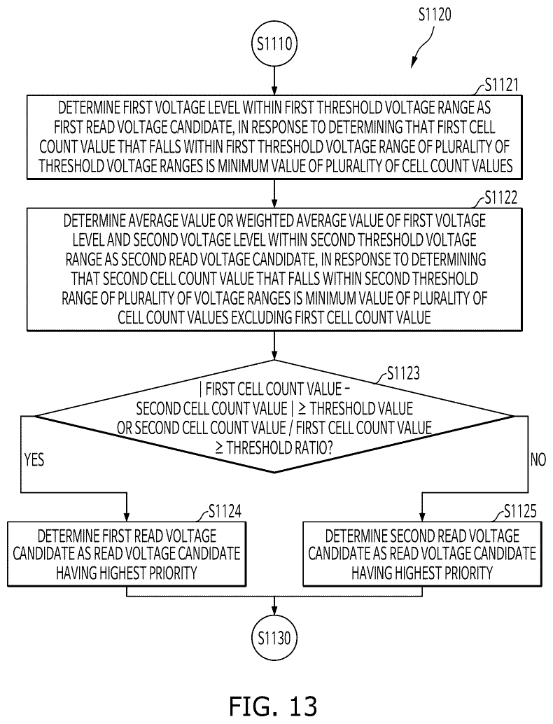

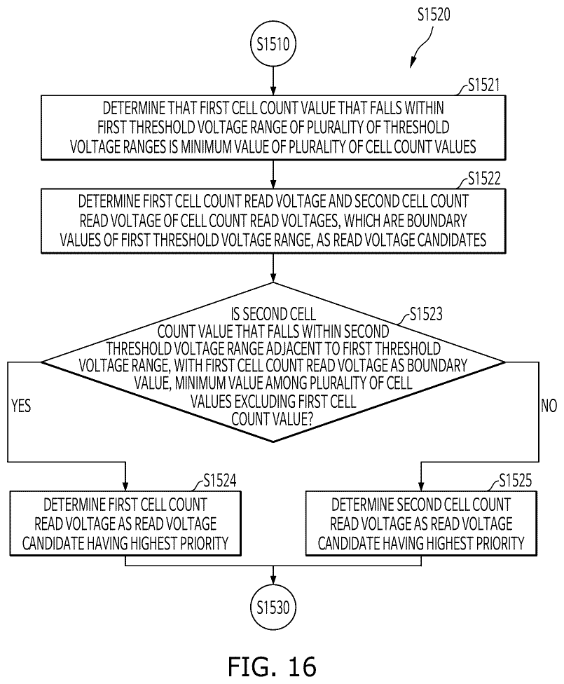

The memory device 100 (or the control logic circuit) may perform a plurality of read operations on the selected word line using the plurality of read voltage candidates determined at S610, at S620. That is, the memory device 100 (or the control logic circuit) may apply each read voltage candidate to the selected memory cells to perform each read operation. For example, a first read operation of the plurality of read operations may be a read operation performed using a first read voltage candidate of a plurality of read voltage candidates. That is, the first read operation may be a read operation performed by applying the first read voltage candidate to the selected memory cells. Likewise, a second read operation of the plurality of read operations may be a read operation performed using a second read voltage candidate of the plurality of read voltage candidates. The number of the plurality of read operations may be the same as the number of the plurality of read voltage candidates, and the plurality of read voltage candidates and the plurality of read operations may have a one-to-one correspondence. Various aspects of determining a plurality of read voltage candidates will be described in detail below with reference to FIGS. 13 and 16.

The memory device 100 may store read data generated through each of the plurality of read operations performed at S620. For example, the memory device 100 may store the generated read data in page buffers of the page buffer circuit (e.g., 130 of FIG. 2) of the memory device 100. For example, read data generated through a plurality of read operations and stored in the memory device 100 (or the page buffer circuit) may include first read data generated through the first read operation, second read data generated through the second read operation, etc.

The memory device 100 (or the control logic circuit) may transmit, to the storage controller 20, the read data stored in the memory device 100 (or the page buffer circuit) and generated through a read operation using any one of the plurality of read voltage candidates, at S630. For example, the memory device 100 may output, from the page buffers, first read data generated through the first read operation using the first read voltage candidate and transmit the first read data to the storage controller 20.

The storage controller 20 may perform error correction on the read data received from the memory device 100 using an error correction circuit (e.g., 22 in FIG. 1) and determine whether the error correction of the read data fails, at S640.

In response to the failure of the error correction of the read data at S640, it may be determined whether the read data for which the error correction has failed is the last read data of the read data generated at S620, at S650.

In response to the determination that the error correction of the read data has failed at S640, and that the read data for which the error correction has failed at S650 is not the last read data, the storage controller 20 may request the memory device 100 to transmit another read data, at S660. The storage controller 20 may request the memory device 100 to transmit another read data through various methods. For example, the storage controller 20 may transmit information or signals indicating that the error correction has failed, or a command (e.g., a dump command) to the memory device 100 to request the memory device 100 to transmit another read data.

In response to the storage controller 20 requesting to transmit the read data at S660, the memory device 100 (or the control logic circuit) may perform a dump operation according to the dump command, at S665. According to the dump operation, the memory device 100 may dump read data different from the previously transmitted read data to the cache latch so that the read data may be output from the page buffer, and may further transmit the read data to the storage controller 20, at S630. For example, in response to the failure of error correction of the first read data in the storage controller 20, the memory device 100 may output, from the page buffers, the second read data generated through the second read operation using the second read voltage candidate and transmit the second read data to the storage controller 20.

The process described above may be repeatedly performed as long as it is determined that the read data for which error correction has failed in the storage controller 20 is not the last read data among the read data generated at S620. For example, in response to the failure of error correction of the second read data in the storage controller 20, the memory device 100 may output, from the page buffers, the third read data generated through the third read operation using the third read voltage candidate. Accordingly, even if error correction of read data for the valley search fails, it is not necessary to generate read data through a separate read command. As a result, there is no latency occurring in the memory device 100 due to the execution of an additional read operation, and it is possible to enhance the performance reliability of the memory device 100.

In response to the determination that the error correction of the read data has failed at S640 and that the read data for which the error correction has failed is the last read data of the read data generated at S620, the storage controller 20 may execute a defense code for the selected memory cells, at S670. That is, in response to the failure of all the error correction of the read data generated through the plurality of read operations at S620, the storage controller 20 may execute a defense code for the selected memory cells. The defense code may be stored in the storage controller 20 (e.g., as firmware) or implemented as dedicated hardware logic, and generally comprises a set of remedial instructions for preserving or recovering data integrity when repeated read attempts or error correction operations fail. For instance, upon activation of the defense code, the storage controller 20 may instruct the memory device 100 to perform advanced read retry sequences at additional voltage steps, relocate data from the selected memory cells to a known-good region in the memory device 100, perform specialized refresh operations to mitigate charge loss or drift in the threshold voltage distribution, or temporarily set the selected memory cells into a lower bit-per-cell mode to reduce further read errors. The defense code may manage diagnostic routines—such as isolating a problematic block for deeper analysis or logging detailed read error information for later evaluation—and may invoke an internal or external error correction scheme more robust than the default scheme. By executing such operations, the storage controller 20 can mitigate severe data reliability issues, improve the likelihood of successful data retrieval, and help ensure that the overall memory system maintains acceptable performance despite overlapping threshold voltage distributions or high program/erase cycle counts. Additionally or alternatively, the storage controller 20 may initiate an error correction process through a soft decision (SD) read operation.

Alternatively, if the error correction is successful at S640, the storage controller 20 may update the table (e.g., 24 in FIG. 1) stored in the internal buffer memory (e.g., 23 in FIG. 1), at S680. In one example, the table updated at S680 may be a history table recording a read voltage input to a selected word line in a read operation in which error correction of read data was successful. That is, the read voltage candidate used in the read operation in which error correction was successful may be determined as the read voltage (e.g., an optimal read voltage) corresponding to the valley between threshold voltage distributions overlapping with each other.

FIG. 6 illustrates that error correction is performed in the storage controller 20, but aspects are not limited thereto. For example, the error correction may be performed in the memory device 100. In this case, the memory device 100 may transmit, to the storage controller 20, a signal indicating that error correction for all read data has failed or a read voltage candidate used for read data for which error correction was successful, and, in response, the storage controller 20 may execute a defense code or update a table.

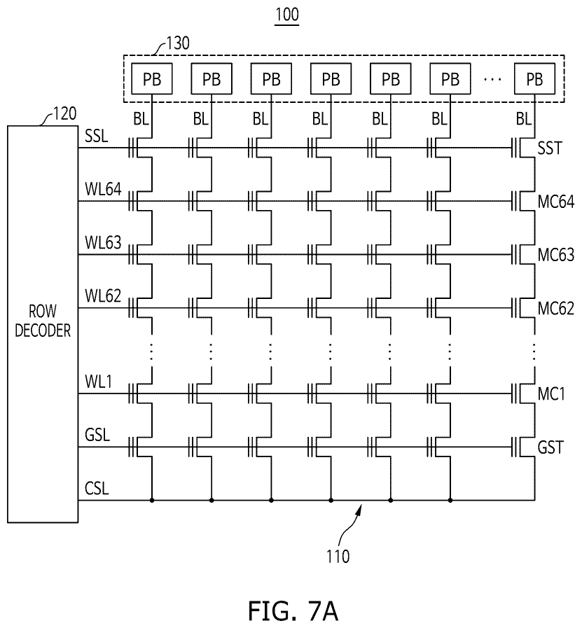

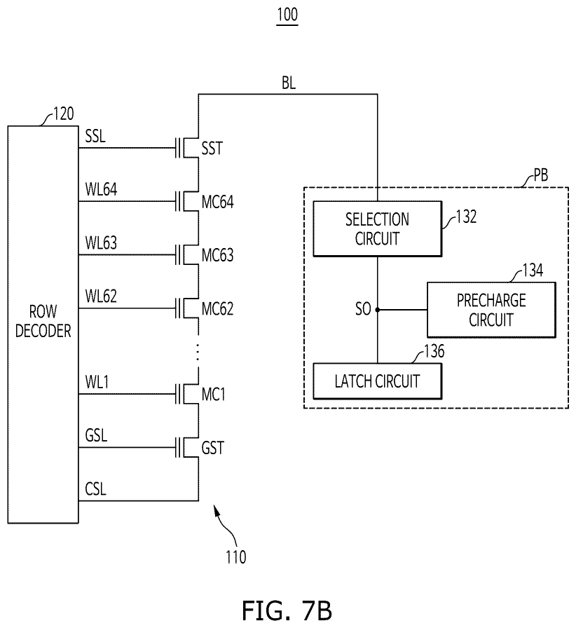

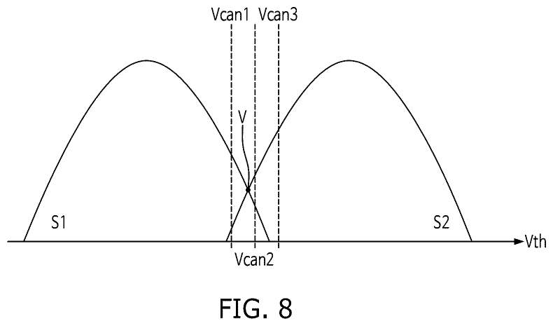

FIG. 7A is a diagram schematically illustrating the memory device, FIG. 7B is a diagram schematically illustrating some components included in the memory device 100 to explain an operation of the memory device, and FIG. 8 is a diagram illustrating an example of a plurality of read voltage candidates applied to a selected word line using the memory device 100 of FIGS. 7A and 7B. The memory device 100 illustrated in FIGS. 7A and 7B may correspond to the memory device 100 of FIG. 2.

Referring to FIG. 7A, the memory cell array 110 may include a plurality of memory cell strings, each of which may include a plurality of memory cells MC1 to MC64, a ground selection transistor GST, and a string selection transistor SST. The number of the plurality of memory cells MC1 to MC64 included in one memory cell string may be variously modified according to aspects.

The row decoder 120 may be connected to the memory cell array 110 through word lines WL1 to WL64, a ground selection line GSL, a string selection line SSL, and the common source line CSL. For example, a plurality of memory cell strings included in the memory cell array 110 may be disposed in one memory block and may share a plurality of word lines WL1 to WL64.

Referring to FIGS. 7A and 7B, the page buffer circuit 130 may include a plurality of page buffers PB, each of which may be connected to a plurality of memory cell strings through each bit line BL. The page buffer PB may include a selection circuit 132, a precharge circuit 134, a latch circuit 136, etc., and a sensing node SO of the page buffer PB may be connected to the bit line BL by the selection circuit 132.

The row decoder 120 may input a predetermined read voltage (e.g., a read voltage candidate to be described below in FIG. 8) to one selected word line SEL WL selected from among the word lines WL1 to WL64. The row decoder 120 may input a pass voltage to the remaining unselected word lines excluding the selected word line SEL WL. The pass voltage may be a voltage capable of turning on the memory cells MC1 to MC64 regardless of the threshold voltages of the memory cells MC1 to MC64, and the read voltage may be a voltage for identifying data stored in the memory cells MC1 to MC64. Therefore, the magnitude of the current flowing through the selected memory cell may be determined according to a comparative magnitude relationship between the read voltage input to the selected word line SEL WL and the threshold voltage of the selected memory cell. Meanwhile, the remaining unselected memory cells may all be turned on by the pass voltage.

Referring to FIG. 8, a plurality of read voltage candidates Vcan1 to Vcan3 applied to the selected word line may be read voltage candidates for determining a read voltage corresponding to the valley V between threshold voltage distributions associated with first and second states S1 and S2 (e.g., two of E and P1 to P7 in FIG. 4B) of the selected memory cells and overlapping with each other. The plurality of read voltage candidates Vcan1 to Vcan3 may be a plurality of read voltage candidates determined at S610 of FIG. 6. FIG. 8 illustrates three read voltage candidates Vcan1 to Vcan3, but aspects are not limited thereto, and two read voltage candidates, four or more read voltage candidates, or any additional number of read voltage candidates may be determined.

Referring to FIGS. 7B and 8, the first to third read voltage candidates Vcan1 to Vcan3 having different levels may be sequentially input to the selected word line such that a plurality of read operations (e.g., a plurality of read operations at S630 of FIG. 6) may be performed. For example, the first read voltage candidate Vcan1 may have the lowest level, and the third read voltage candidate Vcan3 may have the highest level. Once the read operation is executed, the row decoder 120 may input any one of the first to third read voltage candidates Vcan1 to Vcan3 to the selected word line, and input a pass voltage to the remaining unselected word lines.

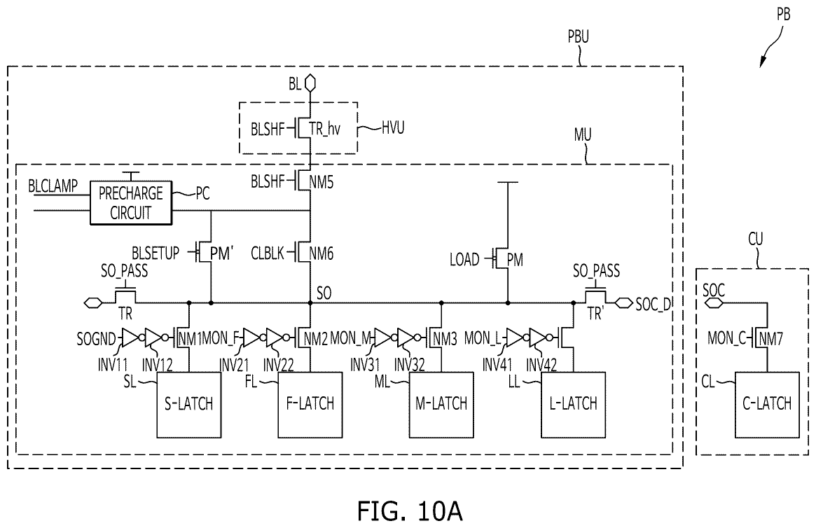

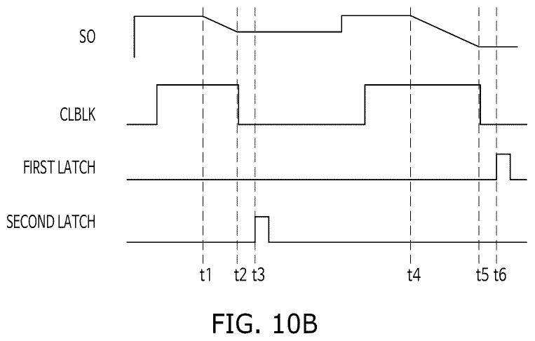

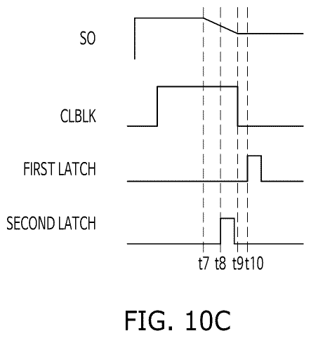

Referring to FIGS. 7B and 8, in each of the plurality of page buffers PB, the precharge circuit 134 may precharge the sensing node SO to a predetermined bias voltage, and connect the sensing node SO to the bit line BL to develop the sensing node SO and store data of each of the selected memory cells connected to the selected word line in the latch circuit 136. Accordingly, the latch circuit 136 may store the first read data generated through the first read operation using the first read voltage candidate Vcan1, the second read data generated through the second read operation using the second read voltage candidate Vcan2, and the third read data generated through the third read operation using the third read voltage candidate Vcan3. Details of the process in which the read data is stored in the latches will be described below with reference to FIGS. 10A to 10C.

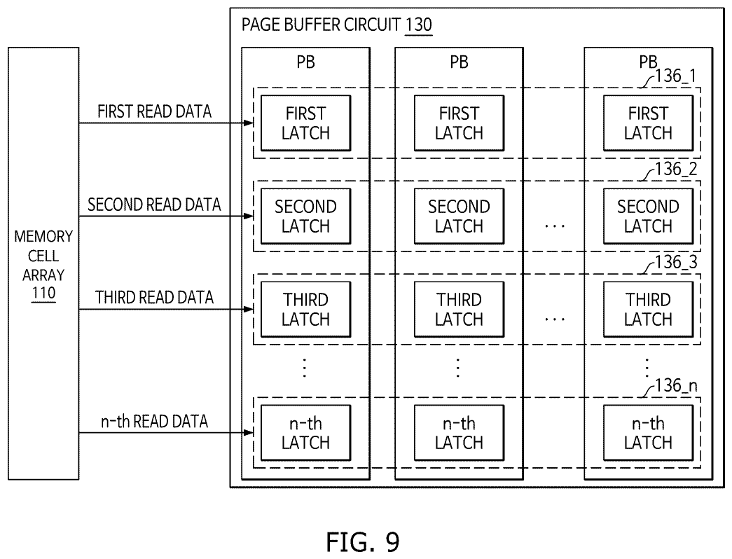

FIG. 9 is a diagram illustrating an example in which the read data is stored in the latch circuit of the page buffer circuit 130.

The page buffer circuit 130 may include page buffers PB, and each of the page buffers PB may include first to n-th latches. That is, the page buffer circuit 130 may include first to n-th latches 136_1 to 136_n (where, n is a natural number greater than or equal to 2). Each of k-th latches 136_k (where, k is a natural number between 1 and n, inclusive) may store data of each of the selected memory cells connected to the selected word line, which is acquired through the read operation using any one of the plurality of read voltage candidates.

Referring to FIGS. 8 and 9, the first latches 136_1 may store the first read data generated through the first read operation using the first read voltage candidate Vcan1. The second latches 136_2 may store the second read data generated through the second read operation using the second read voltage candidate Vcan2. The third latches 136_3 may store the third read data generated through the third read operation using the third read voltage candidate Vcan3. Likewise, the n-th latches 136_n may store the n-th read data generated through the n-th read operation using the n-th read voltage candidate.

FIG. 10A is a diagram illustrating a page buffer PB in detail according to aspects, FIG. 10B is a diagram illustrating an example in which data is stored in different latches of the page buffer PB, and FIG. 10C is a diagram illustrating an example in which data is stored in different latches of the page buffer PB according to another aspect.

Referring to FIG. 10A, the page buffer PB may correspond to an example of the page buffer PB of FIG. 9. The page buffer PB may include a page buffer unit PBU and a cache unit CU. Since the cache unit CU includes cache latches C-LATCH and CL, and the cache latch CL is connected to a data input/output line, the cache unit CU may be disposed adjacent to the data input/output line. Accordingly, the page buffer unit PBU and the cache unit CU may be disposed to be spaced apart from each other, and the page buffer PB may have a separation structure of the page buffer unit PBU-cache unit CU.

The page buffer unit PBU may include a main unit MU. The main unit MU may include main transistors in the page buffer PB. The page buffer unit PBU may further include a bit line selection transistor TR_hv connected to the bit line BL and driven by a bit line selection signal BLSLT. The bit line selection transistor TR_hv may be implemented as a high voltage transistor, and thus the bit line selection transistor TR_hv may be disposed in a well region different from the main unit MU, that is, in a high voltage unit HVU.

The main unit MU may include a sensing latch (S-LATCH) SL, a force latch (F-LATCH) FL, an upper bit latch (M-LATCH) ML, and a lower bit latch L-LATCH LL. The sensing latch SL, the force latch FL, the upper bit latch ML, or the lower bit latch LL may correspond to any one of the first to n-th latches of FIG. 9. According to some aspects, the sensing latch SL, the force latch FL, the upper bit latch ML, or the lower bit latch LL may be referred to as a “main latch”. The main unit MU may further include a precharge circuit PC capable of controlling a precharge operation for the bit line BL or the sensing node SO based on a bit line clamping control signal BLCLAMP, and may further include a transistor PM′ driven by a bit line setup signal BLSETUP.

The upper bit latch ML, the lower bit latch LL, and the cache latch CL may be utilized to store data input from the outside during a program operation, and may be referred to as a “data latch”. If 3-bit data is programmed in one memory cell, the 3-bit data may be stored in the upper bit latch ML, the lower bit latch LL, and the cache latch CL, respectively. The upper bit latch ML, the lower bit latch LL, and the cache latch CL may maintain the stored data until programming of the memory cell is completed. In addition, the cache latch CL may receive, from the sensing latch SL, data read from the memory cell during the read operation and output the data to the outside through the data input/output line.

In addition, the main unit MU may further include first to fourth transistors NM1 to NM4 and a plurality of inverters INV11, INV12, INV21, INV22, INV31, INV32, INV41, and INV42.

The first transistor NM1 may be connected between the sensing node SO and the sensing latch SL, and may be driven by a ground control signal SOGND passing through the inverters INV11 and INV12. The second transistor NM2 may be connected between the sensing node SO and the force latch FL, and may be driven by a forcing monitoring signal MON_F passing through the inverters INV21 and INV22. The third transistor NM3 may be connected between the sensing node SO and the upper bit latch ML, and may be driven by an upper bit monitoring signal MON_M passing through the inverters INV31 and INV32. The fourth transistor NM4 may be connected between the sensing node SO and the lower bit latch LL, and may be driven by a lower bit monitoring signal MON_L passing through the inverters INV41 and INV42.

In addition, the main unit MU may further include fifth and sixth transistors NM5 and NM6 connected in series between the bit line selection transistor TV_hv and the sensing node SO. The fifth transistor NM5 may be driven by a bit line shut-off signal BLSHF, and the sixth transistor NM6 may be driven by a bit line connection control signal CLBLK. In addition, the main unit MU may further include the precharge transistor PM. The pre-charge transistor PM is connected to the sensing node SO, is driven by a load signal LOAD, and pre-charges the sensing node SO to the pre-charge level in the pre-charge period.

The main unit MU may further include a pair of pass transistors, that is, first and second pass transistors TR and TR′ connected to the sensing node SO. The first and second pass transistors TR and TR′ may be referred to as “first and second sensing node connection transistors”. The first and second pass transistors TR and TR′ may be driven according to a pass control signal SO_PASS. The pass control signal SO_PASS may be referred to as a “sensing node connection control signal”. Specifically, the first pass transistor TR may be connected between the first terminal SOC_U and the sensing node SO, and the second pass transistor TR′ may be connected between the sensing node SO and the second terminal SOC_D.

For example, the first terminal SOC_U may be connected to one end of the pass transistor included in a first page buffer unit PBU0, and the second terminal SOC_D may be connected to one end of the pass transistor included in a third page buffer unit PBU3. As a result, the sensing node SO may be electrically connected to a combined sensing node SOC through the pass transistors included in each of third to n+1-th page buffer units PBU2 to PBUn.

Referring to FIG. 10B, the voltage of the sensing node SO may increase to the bias voltage by the precharge operation, and decrease after a first time t1 as the development operation starts. During the falling edge of the bit line connection control signal CLBLK at a second time t2, the voltage of the sensing node SO may be maintained, and subsequently, in response to the sensing signal of the second latch at a third time t3, data of the selected memory cell may be stored in the second latch (e.g., the read operation using the first read voltage candidate). For example, the second latch may be the sensing latch SL of FIG. 10A.

The voltage of the sensing node SO may increase again to the bias voltage by the precharge operation and decrease after a fourth time t4 as the development operation starts again. During the falling edge of the bit line connection control signal CLBLK at a fifth time t5, the voltage of the sensing node SO may be maintained, and subsequently, in response to the sensing signal of the first latch at a sixth time t6, data of the selected memory cell may be stored in the first latch (e.g., the read operation using the second read voltage candidate). For example, the first latch may be the force latch FL of FIG. 10A.

Referring to FIG. 10C, the voltage of the sensing node SO may increase to the bias voltage by the precharge operation, and decrease after a seventh time t7 by the developing operation. Unlike FIG. 10B, while the voltage of the sensing node SO is decreasing, at an eighth time t8, the data of the selected memory cell may be stored in the second latch in response to the sensing signal of the second latch (e.g., the read operation using the first read voltage candidate). During the falling edge of the bit line connection control signal CLBLK at a ninth time t9, the voltage of the sensing node SO may be maintained, and subsequently, in response to the sensing signal of the first latch at a tenth time t10, the data of the selected memory cell may be stored in the first latch (e.g., the read operation using the second read voltage candidate).

Referring back to FIG. 10A, the read data stored in different latches according to the aspects described with reference to FIGS. 10B and 10C, etc. may be dumped into the cache latch CL to be output from the page buffer PB and transmitted to the storage controller. For example, data stored in the sensing latch SL may be dumped to the cache latch CL and transmitted to the storage controller, and in response to the failure of error correction of the read data including the corresponding data, data stored in the force latch FL may be dumped to the cache latch CL and transmitted to the storage controller.

FIG. 11 is a flowchart provided to explain a method 1100 for performing the OVS operation in the storage device of FIG. 5. The method 1100 illustrated in FIG. 11 may be performed by the storage device 1 including the storage controller 20 and the memory device 100 of FIG. 1. In the method 1100 illustrated in FIG. 11, the operations illustrated as being performed by the memory device 100 may be controlled and/or performed by a control logic circuit (e.g., 150 in FIG. 1) of the memory device 100, but aspects are not limited thereto.

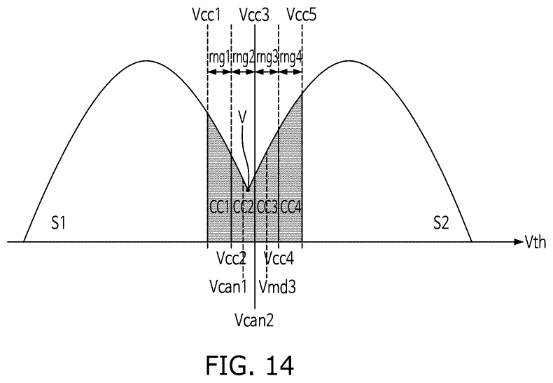

Referring to FIG. 11, in response to the start of the valley search operation at S570 of FIG. 5 (or in response to the memory device 100 receiving the OVS command), the memory device 100 (or the control logic circuit) may perform read operations for cell counting, at S1110. For example, the memory device 100 may apply cell count read voltages to the selected memory cells to calculate a plurality of cell count values that fall within a plurality of threshold voltage ranges distinguished by the cell count read voltages. The plurality of threshold voltage ranges are grouped based on the cell count read voltages. In other words, the cell count read voltages can define boundary values of the plurality of threshold voltage ranges. Turning briefly to FIG. 14, the first threshold voltage range rng1 has boundary values defined by a first cell count read voltage Vcc1 and a second cell count read voltage Vcc2. Similarly, the second threshold voltage range rng2 has boundary values defined by the second cell count read voltage Vcc2 and a third cell count read voltage Vcc3.

The memory device 100 (or the control logic circuit) may determine a plurality of read voltage candidates and priority of each of the plurality of read voltage candidates for determining a read voltage (e.g., an optimal read voltage) corresponding to a valley between overlapping threshold voltage distributions of the selected memory cells connected to the selected word line, at S1120. The threshold voltage distributions overlapping with each other may be threshold voltage distributions associated with any two states (e.g., P1 and P2 of FIG. 4B) of the states of the selected memory cells. The priority of each of the plurality of read voltage candidates may indicate the order in which each of the plurality of read voltage candidates is output from the page buffers of the memory device 100 and transmitted to the storage controller 20.

The memory device 100 may determine a plurality of read voltage candidates and their priorities based on the plurality of cell count values calculated at S1110. Various aspects of determining the plurality of read voltage candidates and their priorities will be described in detail below with reference to FIGS. 13 to 17.

The memory device 100 (or the control logic circuit) may perform a plurality of read operations on the selected word line using the plurality of read voltage candidates determined at S1120, at S1130. For example, a first read operation of the plurality of read operations may be a read operation performed using a first read voltage candidate of a plurality of read voltage candidates. That is, the first read operation may be a read operation performed by applying the first read voltage candidate to the selected memory cells. Likewise, a second read operation of the plurality of read operations may be a read operation performed using a second read voltage candidate of the plurality of read voltage candidates. The number of the plurality of read operations may be the same as the number of the plurality of read voltage candidates, and the plurality of read voltage candidates and the plurality of read operations may have a one-to-one correspondence.

The memory device 100 may store read data generated through each of the plurality of read operations performed at S1130. For example, the memory device 100 may store the generated read data in page buffers of the page buffer circuit (e.g., 130 of FIG. 2) of the memory device 100. For example, read data generated through a plurality of read operations and stored in the memory device 100 (or the page buffer circuit) may include first read data generated through the first read operation, second read data generated through the second read operation, etc.

The memory device 100 (or the control logic circuit) may transmit, to the storage controller 20, the read data stored in the memory device 100 (or the page buffer circuit) and generated through a read operation using any one of the plurality of read voltage candidates, at S1140. The memory device 100 may output, from page buffers, first read data generated through the read operation using the read voltage candidate having the highest (i.e., k=1) priority determined at S1120 and transmit the read data to the storage controller 20. Therefore, the priorities of the plurality of read voltage candidates are associated with a sequence of data output from the page buffers. For example, the read voltage candidates with higher priorities can be output from the page buffers first.

The storage controller 20 may perform error correction on the read data received from the memory device 100 using an error correction circuit (e.g., 22 in FIG. 1) and determine whether the error correction of the read data fails, at S1150.

In response to the failure of the error correction of the read data at S1150, it may be determined whether the read data for which error correction has failed is the lowest-priority read data of the read data generated at S1130, at S1160.

In response to the determination that the error correction of the read data has failed at S1150, and that the read data for which the error correction has failed at S1160 is not the last priority read data, the storage controller 20 may request the memory device 100 to transmit read data (e.g., read data having the next priority), at S1170.

In response to the storage controller 20 requesting to transmit the read data at S1170, the memory device 100 (or the control logic circuit) may perform a dump operation according to the dump command, at S1175. According to the dump operation, the memory device 100 may dump read data having a priority (k+1), following the priority (k) of the previously transmitted read data, to the cache latch so that the read data may be output from the page buffer, and may further transmit the read data to the storage controller 20, at S1140. For example, in response to the failure of the error correction of the first read data in the storage controller 20, the memory device 100 may output, from page buffers, the second read data generated through the second read operation using the second read voltage candidate and having a next priority to that of the first read data, and transmit the second read data to the storage controller 20.

The process described above may be repeatedly performed as long as it is determined that the read data for which error correction has failed is not the last read data.

In response to the determination that the error correction of the read data has failed at S1150, and that the read data for which the error correction has failed is the read data having the last priority, the storage controller 20 may execute a defense code for the selected memory cells, at S1180. That is, in response to the failure of all the error correction of the read data generated through the plurality of read operations at S1130, the storage controller 20 may execute a defense code for the selected memory cells. Additionally or alternatively, the storage controller 20 may initiate an error correction process through a soft decision (SD) read operation.

Alternatively, if the error correction is successful at S1150, the storage controller 20 may update the table (e.g., 24 in FIG. 1) stored in the internal buffer memory (e.g., 23 in FIG. 1), at S1190. In one example, the table updated at S1190 may be a history table recording a read voltage input to a selected word line in a read operation in which error correction of read data was successful. That is, the read voltage candidate used in the read operation in which error correction was successful may be determined as the read voltage (e.g., an optimal read voltage) corresponding to the valley between threshold voltage distributions overlapping with each other.

FIG. 11 illustrates that error correction is performed in the storage controller 20, but aspects are not limited thereto. For example, the error correction may be performed in the memory device 100. In this case, the memory device 100 may transmit, to the storage controller 20, information/signal indicating that error correction for all read data has failed or a read voltage candidate used for read data for which error correction was successful, and, in response, the storage controller 20 may execute a defense code or update a table.

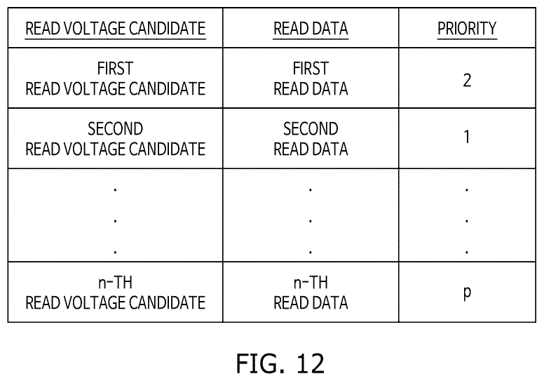

FIG. 12 is a diagram illustrating priorities of the read voltage candidates according to some aspects. In the present disclosure, the priorities of the read voltage candidates and the priorities of read data generated using the corresponding read voltage candidates may be the same as each other, and may be used interchangeably as representing the same meaning. For example, the fact that the first read voltage candidate has the second priority can be understood as meaning that the first read data generated using the first read voltage candidate has the second priority.

The priority of the read voltage candidates illustrated in FIG. 12 may be the priority determined at S1120 of FIG. 11. Although the priorities of the read voltage candidates are illustrated in a table format in FIG. 12, the priorities of the read voltage candidates are not limited thereto, and may be displayed and stored in any format. The priorities of the read voltage candidates of FIG. 12 may be stored in any memory (e.g., register, etc.) in the memory device, and the control logic circuit of the memory device (e.g., 100 in FIG. 11) may use the stored priorities to sequentially transmit the generated read data to the storage controller (e.g., 20 in FIG. 11).

FIG. 13 is a flowchart provided to explain the operation S1120 of FIG. 11 in detail. That is, FIG. 13 is a flowchart provided to explain an aspect of determining a read voltage candidate and its priority.

In response to determining that the first cell count value that falls within the first threshold voltage range of the plurality of threshold voltage ranges distinguished by the cell count read voltages applied to the selected memory cells is the minimum value among the plurality of cell count values at S1110, the memory device 100 (or the control logic circuit) may determine the first voltage level within the first threshold voltage range as a first read voltage candidate, at S1121. The first voltage level may be a midpoint of the first threshold voltage range, but aspects are not limited thereto, and the first voltage level may correspond to any one of the boundary values of the first threshold voltage range.

Likewise, in response to determining that a second cell count value that falls within a second threshold voltage range of the plurality of threshold voltage ranges is a minimum value among the plurality of cell count values excluding the first cell count value (in other words, the second cell count value is a second smallest value among the plurality of cell count values), the memory device 100 (or the control logic circuit) may determine an average value or a weighted average value of the first voltage level and a second voltage level within the second threshold voltage range as a second read voltage candidate, at S1122. In this case, the second voltage level may be a midpoint of the second threshold voltage range, but aspects are not limited thereto, and the second voltage level may correspond to any one of the boundary values of the second threshold voltage range.

The weighted average value at S1122 may be determined based on the first voltage level, the second voltage level, the first cell count value, and the second cell count value. For example, the weighted average value may be a value obtained by dividing the sum of the product of the first voltage level and the second cell count value and the product of the second voltage level and the first cell count value by the sum of the first cell count value and the second cell count value. By determining a read voltage candidate weighted toward a voltage level that falls within the threshold voltage range having a lower cell count value, the probability that the determined read voltage candidate is located close to the valley location may be increased, and the accuracy of the valley search operation may be enhanced.

Alternatively, the first voltage level, the average value of the first voltage level and the second voltage level, and the weighted average value of the first voltage level and the second voltage level may all be determined as read voltage candidates.

Additionally, the second voltage level may be determined as a read voltage candidate.

The memory device 100 (or the control logic circuit) may determine whether the difference between the first cell count value and the second cell count value is greater than or equal to a predetermined threshold value or whether the ratio of the second cell count value to the first cell count value is greater than or equal to a predetermined threshold ratio, at S1123.

In response to determining that the difference between the first cell count value and the second cell count value is greater than or equal to the predetermined threshold value or that the ratio of the second cell count value to the first cell count value is greater than or equal to the predetermined threshold ratio, the memory device 100 (or the control logic circuit) may determine the first read voltage candidate as a read voltage candidate having the highest priority, at S1124. In this case, the priority of the second read voltage candidate may be lower by one level compared to the priority of the first read voltage candidate. This is because, if the difference between the first cell count value and the second cell count value is greater than or equal to the predetermined threshold value or if the ratio of the second cell count value to the first cell count value is greater than or equal to the predetermined threshold ratio, the second threshold voltage range is more likely to be a threshold voltage range that is farther away from the actual location of the valley compared to the first threshold voltage range, and thus it is less likely that a specific voltage level within the second threshold voltage range (e.g., a midpoint of the second threshold voltage range) corresponds to or is similar to the optimal read voltage corresponding to the valley.

Alternatively, in response to determining that the difference between the first cell count value and the second cell count value is less than the predetermined threshold value or that the ratio of the second cell count value to the first cell count value is less than the predetermined threshold ratio, the memory device 100 (or the control logic circuit) may determine the second read voltage candidate as a read voltage candidate having the highest priority, at S1125. In this case, the priority of the first read voltage candidate may be one level lower than the priority of the second read voltage candidate. This is because, if the difference between the first cell count value and the second cell count value is less than the predetermined threshold value or if the ratio of the second cell count value to the first cell count value is less than the predetermined threshold ratio, it is highly likely that both a specific voltage level within the first threshold voltage range (e.g., a midpoint in the first threshold voltage range) and a specific voltage level within the second threshold voltage range (e.g., a midpoint in the second threshold voltage range) are closer to the optimal read voltage corresponding to the valley.

In other aspects, if the first voltage level, the average value of the first voltage level and the second voltage level, the weighted average value of the first voltage level and the second voltage level are read voltage candidates, the priority may be lowered in the order of the first voltage level, the weighted average value of the first voltage level and the second voltage level, and the average value of the first voltage level and the second voltage level at S1124. Alternatively, at S1125, the priority may be lowered in the order of the weighted average value of the first voltage level and the second voltage level, the average value of the first voltage level and the second voltage level, and the first voltage level.

FIG. 14 is a diagram illustrating an example of determining a read voltage corresponding to the valley V using a plurality of read voltage candidates Vcan1 and Vcan2. The read voltage corresponding to the plurality of read voltage candidates Vcan1 and Vcan2 and the valley V may be determined based on the aspect illustrated and described with reference to FIGS. 11 and 13. The plurality of read voltage candidates Vcan1 to Vcan3 may be read voltage candidates for determining a read voltage corresponding to the valley V between threshold voltage distributions associated with the first and second states S1 and S2 (e.g., two of E and P1 to P7 of FIG. 4B) of the selected memory cells and overlapping with each other.

Referring to S1110 of FIG. 11 and also to FIG. 14, the memory device 100 (or the control logic circuit) may apply cell count read voltages Vcc1 to Vcc5 to the selected memory cells to calculate a plurality of cell count values CC1 to CC4 that fall within a plurality of threshold voltage ranges rng1 to rng4 distinguished by the cell count read voltages Vcc1 to Vcc5. FIG. 14 illustrates that four cell count values are calculated, but aspects are not limited thereto. The position of each of the plurality of threshold voltage ranges rng1 to rng4 may be arbitrarily determined or may be determined based on an existing optimal read voltage stored in a table (e.g., 24 in FIG. 1) stored in the storage controller. The widths of each of the plurality of threshold voltage ranges rng1 to rng4 may be the same as or different from each other.

Referring to S1121 of FIG. 13 and also to FIG. 14, in response to determining that a second cell count value CC2 that falls within a second threshold voltage range rng2 of the plurality of threshold voltage ranges rng1 to rng4 is the minimum value among the plurality of cell count values CC1 to CC4, the memory device 100 (or the control logic circuit) may determine a second voltage level within the second threshold voltage range rng2 as the first read voltage candidate Vcan1. The voltage level of the first read voltage candidate Vcan1 may be a midpoint of the second threshold voltage range rng2.

Referring to S1122 of FIG. 13 and also to FIG. 14, in response to determining that a third cell count value CC3 that falls within a third threshold voltage range rng3 of the plurality of threshold voltage ranges rng1 to rng4 is the minimum value among the plurality of cell count values CC1 to CC4 excluding the second cell count value CC2, the memory device 100 (or a control logic circuit) may determine an average value or a weighted average value of a second voltage level Vcan1 and a third voltage level Vmd3 within the third threshold voltage range rng3 as the second read voltage candidate Vcan2.

Referring to S1123 of FIG. 13 and also to FIG. 14, the memory device 100 (or the control logic circuit) may determine whether a difference between the second cell count value CC2 and the third cell count value CC3 is greater than or equal to a predetermined threshold value or whether a ratio of the third cell count value CC3 to the second cell count value CC2 is greater than or equal to a predetermined threshold ratio.

Referring to S1124 of FIG. 13 and also to FIG. 14, in response to determining that the difference between the second cell count value CC2 and the third cell count value CC3 is greater than or equal to the predetermined threshold value or that the ratio of the third cell count value CC3 to the second cell count value CC2 is greater than or equal to the predetermined threshold ratio, the memory device 100 (or the control logic circuit) may determine the first read voltage candidate Vcan1 as a read voltage candidate having the highest priority.

Referring to S1125 of FIG. 13 and also to FIG. 14, in response to determining that the difference between the second cell count value CC2 and the third cell count value CC3 is less than the predetermined threshold value or that the ratio of the third cell count value CC3 to the second cell count value CC2 less than the predetermined threshold ratio, the memory device 100 (or the control logic circuit) may determine the second read voltage candidate Vcan2 as a read voltage candidate having the highest priority.

Referring to S1130 of FIG. 11 and also to FIG. 14, the memory device 100 (or the control logic circuit) may generate read data through a plurality of read operations using the plurality of read voltage candidates Vcan1 and Vcan2 and store the read data in the page buffers.

In response to the first read voltage candidate Vcan1 being determined as the read voltage candidate having the highest priority and to the success of error correction of read data generated by the read operation performed using the first read voltage candidate Vcan1, the storage controller 20 may determine the first read voltage candidate Vcan1 as a read voltage corresponding to the valley V between the threshold voltage distributions. Alternatively, in response to the failure of error correction of read data generated by the read operation performed using the first read voltage candidate Vcan1, the memory device 100 (or the control logic circuit) may output read data generated through a read operation using the second read voltage candidate Vcan2 from the page buffers and transmit the read data to the storage controller 20.

In response to the second read voltage candidate Vcan2 being determined as the read voltage candidate having the highest priority and to the success of error correction of read data generated by the read operation performed using the second read voltage candidate Vcan2, the storage controller 20 may determine the second read voltage candidate Vcan2 as a read voltage corresponding to the valley V between the threshold voltage distributions. Alternatively, in response to the failure of error correction of read data generated by the read operation performed using the second read voltage candidate Vcan2, the memory device 100 (or the control logic circuit) may output read data generated through the read operation using the first read voltage candidate Vcan1 from the page buffers and transmit the read data to the storage controller 20.

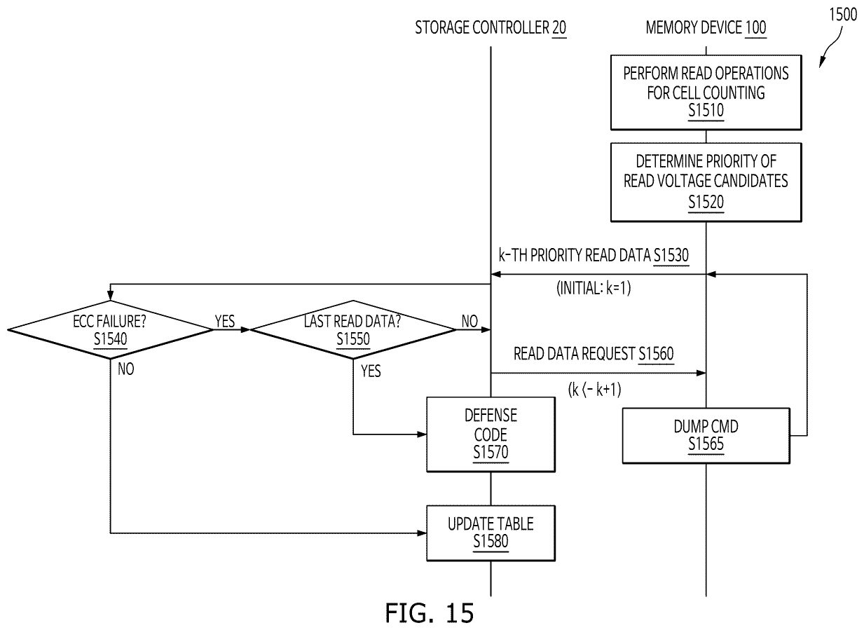

FIG. 15 is a flowchart provided to explain a method 1500 for performing the OVS operation in the storage device of FIG. 5. The method 1500 illustrated in FIG. 15 may be performed by the storage device 1 including the storage controller 20 and the memory device 100 of FIG. 1. In the method 1500 illustrated in FIG. 15, the operations illustrated as being performed by the memory device 100 may be controlled and/or performed by a control logic circuit (e.g., 150 in FIG. 1) of the memory device 100, but aspects are not limited thereto. In FIG. 15, operations S1530 to S1580 excluding operations S1510 and S1520 correspond to operations S1140 to S1190 excluding operations S1110 to S1130 in FIG. 11, and descriptions of the operations S1530 to S1580 overlapping with those of FIG. 11 will be omitted below.

Referring to FIG. 15, in response to the start of the valley search operation at S570 of FIG. 5 (or in response to the memory device 100 receiving the OVS command), the memory device 100 (or the control logic circuit) may perform read operations for cell counting, at S1510. For example, the memory device 100 may apply cell count read voltages to the selected memory cells to calculate a plurality of cell count values that fall within a plurality of threshold voltage ranges distinguished by the cell count read voltages. As the read operations are performed at S1510, read data is generated, and the memory device 100 (or the page buffer circuit) may store the generated read data. For example, the page buffer circuit may store first read data generated through a read operation using a first cell count read voltage and second read data generated through a read operation using a second cell count read voltage.

At least some of the cell count read voltages may be determined as read voltage candidates. By directly using the cell count read voltages as the read voltage candidates, a read voltage corresponding to the valley may be determined without performing an additional read operation with separately determined read voltage candidates, thus allowing the valley search operation to be efficiently performed.

The memory device 100 (or the control logic circuit) may determine the priority of each of the plurality of read voltage candidates, at S1520. Details of a process of determining the priority will be described in detail below with reference to FIG. 16.

FIG. 16 is a flowchart provided to explain the operation S1520 of FIG. 15 in detail.

The memory device 100 (or the control logic circuit) may determine that the first cell count value that falls within the first threshold voltage range of the plurality of threshold voltage ranges is the minimum value among the plurality of cell count values, at S1521. In response, the memory device 100 (or the control logic circuit) may determine the first cell count read voltage and the second cell count read voltage, which are boundary values of the first threshold voltage range of the cell count read voltages, as read voltage candidates, at S1522. Through operations S1523 to S1525, the memory device 100 (or the control logic circuit) may determine the first cell count read voltage or the second cell count read voltage as a read voltage candidate having the highest priority.

The memory device 100 (or the control logic circuit) may determine whether the second threshold voltage range, adjacent to the first threshold voltage range and defined by the first cell count read voltage as a boundary value, is the minimum value among the plurality of cell count values excluding the first cell count value, at S1523.

In response to determining that the second threshold voltage range, adjacent to the first threshold voltage range and defined by the first cell count read voltage as a boundary value, is the minimum value among the plurality of cell count values excluding the first cell count value, the memory device 100 (or the control logic circuit) may determine the first cell count read voltage as a read voltage candidate having the highest priority, at S1524.

On the other hand, in response to determining that the second cell count value that falls within the second threshold voltage range, adjacent to the first threshold voltage range and defined by the first cell count read voltage as a boundary value, is not the minimum value among the plurality of cell count values excluding the first cell count value, the memory device 100 (or the control logic circuit) may determine the second cell count read voltage as a read voltage candidate having the highest priority, at S1525.

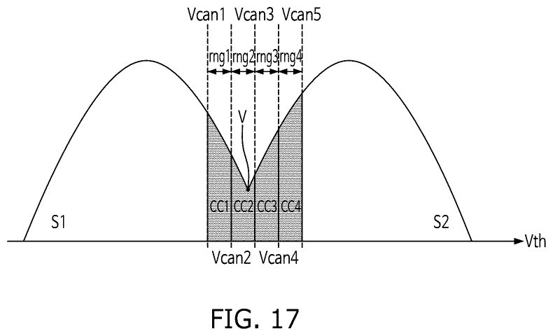

FIG. 17 is a diagram provided to explain an example of determining a read voltage corresponding to the valley V using a plurality of read voltage candidates Vcan1 to Vcan5.

The read voltage corresponding to the valley V of FIG. 17 may be determined according to the aspect illustrated and described with reference to FIGS. 15 and 16. The plurality of read voltage candidates Vcan1 to Vcan5 may be cell count read voltages. FIG. 17 illustrates five read voltage candidates Vcan1 to Vcan5 and four threshold voltage ranges rng1 to rng4, but aspects are not limited thereto. The position of each of the plurality of threshold voltage ranges rng1 to rng4 may be arbitrarily determined or may be determined based on an existing optimal read voltage stored in a table (e.g., 24 in FIG. 1) stored in the storage controller. The widths of each of the plurality of threshold voltage ranges rng1 to rng4 may be the same as or different from each other.

Referring to S1521 of FIG. 16 and also to FIG. 17, the memory device 100 (or the control logic circuit) may determine that the second cell count value CC2 that falls within the second threshold voltage range rng2 of the plurality of threshold voltage ranges rng1 to rng4 is the minimum value among the plurality of cell count values CC1 to CC4, at S1521.

Referring to S1522 of FIG. 16 and also to FIG. 17, the memory device 100 (or the control logic circuit) may determine, as read voltage candidates, a second cell count read voltage Vcan2 and a third cell count read voltage Vcan3 which are boundary values of the second threshold voltage range rng2 from which the cell count value is determined as the minimum value.

Referring to S1523 of FIG. 16 and also to FIG. 17, the memory device 100 (or the control logic circuit) may determine whether the first cell count value CC1 that falls within the first threshold voltage range rng1 adjacent to the second threshold voltage range rng2 and defined by the second cell count read voltage Vcan2 as a boundary value is the minimum value among a plurality of cell count values CC1, CC3, and CC4 excluding the second cell count value CC2.

Referring to S1524 of FIG. 16 and also to FIG. 17, in response to determining that the first cell count value CC1 is the minimum value among the plurality of cell count values CC1, CC3, and CC4, the memory device 100 (or the control logic circuit) may determine the second cell count read voltage Vcan2 as a read voltage candidate having the highest priority.

Alternatively, referring to S1525 of FIG. 16 and also to FIG. 17, in response to determining that the first cell count value CC1 is not the minimum value among the plurality of cell count values CC1, CC3, and CC4, the memory device 100 (or the control logic circuit) may determine the third cell count read voltage Vcan3 as a read voltage candidate having the highest priority.

The operations S1523 to S1525 of FIG. 16 may be performed in the opposite direction to that described above. For example, the memory device 100 may determine whether the third cell count value CC3 that falls within the third threshold voltage range rng3, adjacent to the second threshold voltage range rng2 and defined by the third cell count read voltage CC3 as a boundary value, is the minimum value among the plurality of cell count values CC1, CC3, and CC4 excluding the second cell count value CC2. In response to determining that the third cell count value CC3 is the minimum value among the plurality of cell count values CC1, CC3, and CC4, the memory device 100 may determine the third cell count read voltage Vcan3 as a read voltage candidate having the highest priority. Alternatively, in response to determining that the third cell count value CC3 is not the minimum value among the plurality of cell count values CC1, CC3, and CC4, the memory device 100 may determine the second cell count read voltage Vcan2 as a read voltage candidate having the highest priority.

Referring to FIGS. 15 and 17, in response to the success of error correction of read data generated through the read operation using one of the second cell count read voltage Vcan2 and the third cell count read voltage Vcan3, the storage controller 20 may determine the corresponding cell count read voltage (or read voltage candidate) as a read voltage corresponding to the valley V between threshold voltage distributions. Alternatively, in response to the failure of error correction of read data generated using one of the second cell count read voltage Vcan2 and the third cell count read voltage Vcan3, the memory device 100 may output read data generated through the read operation using the other one of the second cell count read voltage Vcan2 and the third cell count read voltage Vcan3 from the page buffers and transmit the read data to the storage controller 20.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

1. A storage device, comprising:
a memory device comprising a word line connected with memory cells and page buffers configured to sense states of the memory cells; and
a storage controller configured to transmit, to the memory device, a command indicating a valley search operation on the word line,
wherein the memory device is configured to:
based on the command, determine a plurality of read voltage candidates for determining a read voltage, wherein the read voltage corresponds to a valley between a first threshold voltage distribution that is associated with a first state of the states of the memory cells and a second threshold voltage distribution that is associated with a second state of the states of the memory cells, and the first and second threshold voltage distributions overlap with one another;
generate read data through a plurality of read operations using the plurality of read voltage candidates on the word line and store the read data in the page buffers;
output, from the page buffers, first read data of the read data generated through a first read operation of the plurality of read operations using a first read voltage candidate of the plurality of read voltage candidates;
transmit the first read data to the storage controller;
based on a failure of error correction of the first read data in the storage controller, output, from the page buffers, second read data of the read data generated through a second read operation of the plurality of read operations using a second read voltage candidate of the plurality of read voltage candidates; and
transmit the second read data to the storage controller.

2. The storage device of claim 1, wherein the storage controller is configured to determine, based on a success of error correction of the second read data, the second read voltage candidate as the read voltage corresponding to the valley between the first and second threshold voltage distributions.

3. The storage device of claim 1, wherein the memory device is configured to output from the page buffers, based on a failure of error correction of the second read data in the storage controller, third read data of the read data generated through a third read operation of the plurality of read operations using a third read voltage candidate of the plurality of read voltage candidates.

4. The storage device of claim 1, wherein the storage controller is configured to execute, based on a failure of all error correction of the read data generated through the plurality of read operations in the storage controller, a defense code associated with the memory cells.

5. The storage device of claim 1, wherein
each of the page buffers comprises a respective first latch and a respective second latch,
the first latches of the page buffers are configured to store the first read data, and
the second latches of the page buffers are configured to store the second read data.

6. A storage device, comprising:
a memory device comprising a word line connected with memory cells and page buffers configured to sense states of the memory cells; and
a storage controller configured to transmit, to the memory device, a command indicating a valley search operation on the word line,
wherein the memory device is configured to:
based on the command, determine a plurality of read voltage candidates for determining a read voltage, wherein the read voltage corresponds to a valley between a first threshold voltage distribution that is associated with a first state of the states of the memory cells and a second threshold voltage distribution that is associated with a second state of the states of the memory cells, and the first and second threshold voltage distributions overlap with one another;
generate read data through a plurality of read operations using the plurality of read voltage candidates on the word line;
store the read data in the page buffers;
determine a priority of each of the plurality of read voltage candidates;
output, from the page buffers, first read data of the read data generated through a read operation of the plurality of read operations using a read voltage candidate of the plurality of read voltage candidates that has a highest determined priority; and
transmit the first read data to the storage controller.

7. The storage device of claim 6, wherein the memory device is configured to:
calculate, by applying cell count read voltages to the memory cells, a plurality of cell count values that respectively correspond to a plurality of threshold voltage ranges, wherein the plurality of threshold voltage ranges are grouped based on the cell count read voltages; and
based on the plurality of cell count values, determine the plurality of read voltage candidates and the priorities of the plurality of read voltage candidates, wherein the priorities of the plurality of read voltage candidates are associated with a sequence of data output from the page buffers.

8. The storage device of claim 7, wherein
the memory device is configured to:
based on determining that a first cell count value that corresponds to a first threshold voltage range of the plurality of threshold voltage ranges is a minimum value of the plurality of cell count values, determine a first voltage level within the first threshold voltage range as a first read voltage candidate; and
based on determining that a second cell count value that corresponds to a second threshold voltage range of the plurality of threshold voltage ranges is a second smallest value of the plurality of cell count values, determine an average value or a weighted average value as a second read voltage candidate, and
wherein the average value is determined based on the first voltage level and a second voltage level within the second threshold voltage range, and the weighted average value is determined based on the first voltage level, the second voltage level, the first cell count value, and the second cell count value.

9. The storage device of claim 8, wherein
the first voltage level is a midpoint of the first threshold voltage range, and
the second voltage level is a midpoint of the second threshold voltage range.

10. The storage device of claim 8, wherein the memory device is configured to determine, based on a difference between the first cell count value and the second cell count value being greater than or equal to a predetermined threshold value or a ratio of the second cell count value to the first cell count value being greater than or equal to a predetermined threshold ratio, the first read voltage candidate as a read voltage candidate having a highest priority.

11. The storage device of claim 10, wherein the storage controller is configured to determine, based on a success of error correction of the first read data, the first read voltage candidate as the read voltage corresponding to the valley between the first and second threshold voltage distributions.

12. The storage device of claim 10, wherein the memory device is configured to:
based on a failure of error correction of the first read data, output, from the page buffers, second read data generated through a read operation of the plurality of read operations using the second read voltage candidate of the plurality of read voltage candidates; and
transmit the second read data to the storage controller.

13. The storage device of claim 8, wherein the memory device is configured to, based on determining that a difference between the first cell count value and the second cell count value is less than a predetermined threshold value or that a ratio of the second cell count value to the first cell count value is less than a predetermined threshold ratio, determine the second read voltage candidate as a read voltage candidate having a highest priority.

14. The storage device of claim 13, wherein the memory device is configured to, based on a failure of error correction of the first read data, output, from the page buffers, second read data generated through a read operation of the plurality of read operations using the first read voltage candidate of the plurality of read voltage candidates.

15. The storage device of claim 6, wherein
the memory device is configured to apply cell count read voltages to the memory cells and calculate a plurality of cell count values that respectively correspond to a plurality of threshold voltage ranges, the plurality of threshold voltage ranges being grouped based on the cell count read voltages, and
the plurality of read voltage candidates comprise at least one of the cell count read voltages.

16. The storage device of claim 15, wherein
the memory device is configured to:
based on determining that a first cell count value that corresponds to a first threshold voltage range of the plurality of threshold voltage ranges is a minimum value of the plurality of cell count values, determine a first cell count read voltage and a second cell count read voltage as part of the plurality of read voltage candidates, wherein the first and second cell count read voltages are boundary values of the first threshold voltage range; and
determine the first cell count read voltage or the second cell count read voltage as a read voltage candidate having a highest priority.

17. The storage device of claim 16, wherein the memory device is configured to, based on determining that a second cell count value that corresponds to a second threshold voltage range is a second smallest value of the plurality of cell count values, determine the first cell count read voltage as the read voltage candidate having the highest priority, wherein the second threshold voltage range is adjacent to the first threshold voltage range and has a boundary value of the first cell count read voltage.

18. The storage device of claim 17, wherein the storage controller is configured to, based on a success of error correction of the first read data, determine the first cell count read voltage as the read voltage corresponding to the valley between the first and second threshold voltage distributions.

19. The storage device of claim 17, wherein the memory device is configured to, based on a failure of error correction of the first read data, output, from the page buffers, second read data generated through a read operation of the plurality of read operations using the second cell count read voltage.

20. A memory device, comprising:
a memory cell array comprising memory cells;
a page buffer circuit comprising page buffers connected to the memory cells through bit lines, the page buffers configured to sense states of memory cells of the memory cells that are connected to a word line; and
a control logic circuit configured to control the page buffer circuit,
wherein the control logic circuit is configured to:
determine a plurality of read voltage candidates for determining a read voltage, wherein the read voltage corresponds to a valley between a first threshold voltage distribution that is associated with a first state of the states of the memory cells and a second threshold voltage distribution that is associated with a second state of the states of the memory cells, and the first and second threshold voltage distributions overlap with one another;
generate read data through a plurality of read operations using the plurality of read voltage candidates on the word line and store the read data in the page buffers;
output, from the page buffers, first read data of the read data generated through a first read operation of the plurality of read operations using a first read voltage candidate of the plurality of read voltage candidates; and
based on a failure of error correction of the first read data, output, from the page buffers, second read data generated through a second read operation of the plurality of read operations using a second read voltage candidate of the plurality of read voltage candidates.
